(19) United States
(12) Patent Application Publication
(10) Pub. No.: US 2014/0229348 A1
(43) Pub. Date: Aug. 14, 2014

(54) ELECTRONIC INVOICE MANAGEMENT AND PRINTING

(71) Applicant: HEWLETT-PACKARD DEVELOPMENT COMPANY, L.P., Houston, TX (US)

(72) Inventors: Ketankumar Navneetray Vyas, Bangalore (IN); Balasubramanian Gopalakrishnan, Bangalore (IN)

(73) Assignee: Hewlett-Packard Development Company, L.P., Houston, TX (US)

(21) Appl. No.: 13/858,668

(22) Filed: Apr. 8, 2013

(30) Foreign Application Priority Data
Feb. 8, 2013 (IN) 539/CHE/2013

(51) Int. Cl. G06Q 20/04

(52) U.S. Cl. CPC G06Q 20/0457
USPC 705/35

(57) ABSTRACT

Provided is a method of managing electronic invoices. An electronic invoice of a customer is stored in an online database. A mobile phone number of the customer is associated with the electronic invoice and said association is stored in the online database. A unique Uniform Resource Locator (URL) is generated and associated with the electronic invoice. The URL is sent to a mobile device associated with the mobile phone number of the customer via a messaging service.

### CLAIM FOR PRIORITY

The present application claims priority under 35 U.S.C 119 (a)-(d) to Indian Patent application number 539/CHE/2013, filed on Feb. 8, 2013, which is incorporated by reference in its entirety.

### BACKGROUND

People buy products and services all the time. During a typical purchase, for instance in a retail outlet, a paper invoice is given to a customer as proof of purchase. Needless to say, due to the nature of the medium, it is difficult to preserve paper invoices for a long period of time—they could get misplaced, soiled, damaged, or faded. This could be an issue if a paper invoice is required to be preserved for purposes like warranty, guarantee, delivery of goods, after sales service, legal proceedings, etc.

### BRIEF DESCRIPTION OF THE DRAWINGS

For a better understanding of the solution, embodiments will now be described, purely by way of example, with reference to the accompanying drawings, in which:

FIG. 1 is a schematic block diagram of an electronic invoice management system, according to an example.

FIG. 2 is a schematic block diagram of an electronic invoice printing system based on electronic invoice management system of FIG. 1, according to an example.

FIG. 3 illustrates a database, according to an example.

FIG. 4 illustrates a method of managing electronic invoices, according to an example.

FIG. 5 illustrates a method of printing electronic invoices, according to an example.

### DETAILED DESCRIPTION OF THE INVENTION

For the sake of clarity, it may be mentioned that terms “invoice” and “receipt” are used interchangeably in this document.

In a typical sales transaction, a paper invoice is provided to a customer as proof of purchase of a product or service. As mentioned earlier, paper invoices are difficult to preserve for long periods of time. They could get lost, stolen, damaged, etc. thereby making it difficult for a customer to claim warranty, an after sales service, or any other legal right in future. Presently, there are no easy solutions for a customer or an individual to manage his or her sales invoices or invoices. Also, in case a print invoice (or invoice) gets misplaced, damaged, faded, etc., it may not be easy for a customer to obtain another printed copy of the invoice.

Proposed is a solution that simplifies invoice management for customers. Proposed solution allows vendors to make an electronic copy of invoices available to their customers in a client-server or cloud computing environment. It allows a customer to manage and print an invoice using a mobile phone. It also allows an individual to reprint an invoice at a later stage if the original paper based invoice is lost or damaged.

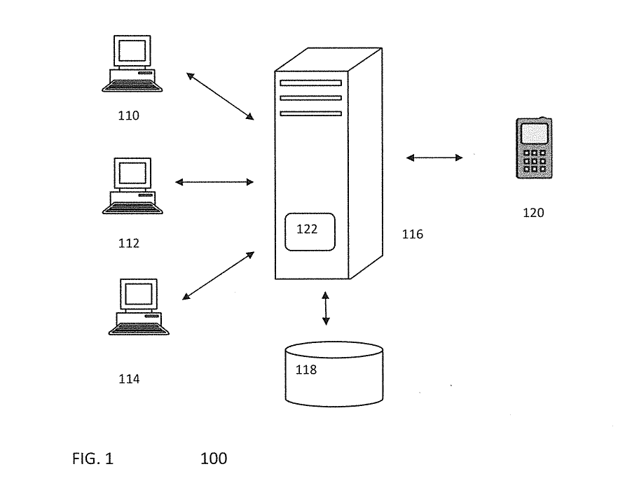

FIG. 1 is a schematic block diagram of an electronic invoice management system, according to an example.

Electronic invoice management system 100 may include source systems 110, 112, 114, computer server 116, database 118, and mobile phone 120. Various components of electronic invoice management system 100 i.e. source systems 110, 112, 114, computer server 116, database 118 and mobile phone 120 could be connected over a network, which may be wired or wireless (for example, a telecom network). The network may be a public network such as the Internet, or a private network such as an intranet.

Source systems 110, 112, 114 may be a computing device such as, but not limited to, a desktop computer, a notebook computer, a tablet computer, a computer server, a mobile phone, or a personal digital assistant (PDA). In an implementation, source systems 110, 112, 114 are point-of-sale terminals with the ability to capture customer orders, process credit and debit cards, connect to other systems in a network, etc. Source systems 110, 112, 114 could belong to a single vendor (for example, a retail outlet A) or multiple vendors (for example, retail outlets A, B and C respectively). Also, source systems 110, 112, 114 could be manufactured by a single vendor or multiple vendors. Source systems 110, 112, 114 may be connected to computer server 116 through a communication network which may be wired or wireless.

Source systems 110, 112, 114 may include a storage device for storing a computer application (machine readable instructions), for example, an invoice generation application. Invoice generation application generates an invoice in a source system to create a record of a sale transaction. For generating a physical copy of an invoice, invoice generation module transmits the invoice to a printer which then generates a paper based invoice (“print invoice”). Invoice generation module may also generate an electronic or digital version of an invoice (“electronic invoice”). An electronic invoice may be generated in a variety of file formats. Some non-limiting examples may include .doc, .tiff, .jpeg, .pdf, etc.

Invoice generation module may also associate a mobile phone number of a customer with an electronic invoice of the customer. To provide an illustration, at the time of generation of an invoice upon a sale transaction, a billing assistant may obtain a customer's mobile phone number. The customer's mobile phone number could be fed into the invoice generation module which may associate the mobile phone number with the customer's invoice. In an implementation, invoice generation module transmits a customer's electronic invoice along with an associated mobile phone number of the customer to computer server 116. It may be mentioned that number of source systems illustrated in FIG. 1 is by way of example and not limitation.

Computer server 116 is a computer or computer application (machine executable instructions) that provides services to other computers or computer applications. Computer server 116 may include a processor, a memory, and a communication interface. The components of computer server may be coupled together through a system bus. Processor may include any type of processor, microprocessor, or processing logic that interprets and executes instructions. Memory may include a random access memory (RAM) or another type of dynamic storage device that may store information and instructions non-transitorily for execution by processor. In an implementation, memory may include an electronic invoice management module 122. Communication interface may include any transceiver-like mechanism that enables computer server 116 to communicate with other devices and/or systems via a communication link. Communication interface may be a software program, a hard ware, a firmware, or any combination thereof. Communication interface may use a variety of communication technologies to enable communication between computer server and another computer system such as source systems 110, 112 and 114 or any other computing device. To provide a few non-limiting examples, communication interface may be an Ethernet card, a modem, an integrated services digital network (“ISDN”) card, etc.

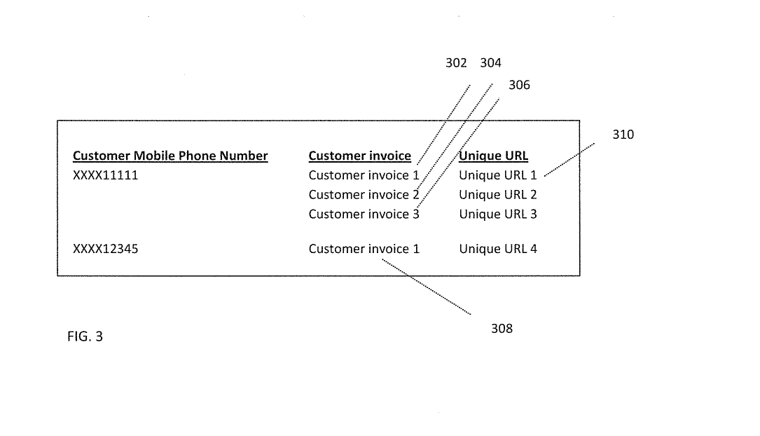

Electronic invoice management module 122 receives an electronic invoice from a source system (such as source systems 110, 112, and 114). In an implementation, electronic invoice management module 122 receives an electronic invoice of a customer from an invoice generation module of a source system. An electronic invoice received in such manner may also include mobile phone number of the customer. Electronic invoice management module 122 records the association between a customer's mobile phone number and the customer's electronic invoice in database 118. Electronic invoice management module 122 may also generate and associate a unique Uniform Resource Locator (URL) with an electronic invoice of a customer. The aforesaid URL represents a unique address for the associated electronic invoice in database 118. In an implementation, a URL corresponding to an electronic invoice is also saved along with the electronic invoice and mobile phone number of a customer in database 118. FIG. 3 illustrates an association between a customer's mobile number, electronic invoices of said customer and unique URLs corresponding to said invoices in database 118, according to an example. Referring to FIG. 3, in an instance, database 118 may store data in a tabular format. However, there are many other mechanisms for storing data, for example in an object format or hierarchal format. Electronic invoices for purchases made by a customer are linked to his or her mobile phone number. For example, electronic customer invoices (302, 304 and 306) of a customer are linked to his mobile phone number XXXX11111. Similarly, electronic invoice (308) of another customer is associated with her mobile phone number XXXX12345. Each customer's invoice is associated with a unique URL. For example, customer invoice 302 is linked to unique URL 1 (310).

Electronic invoice management module 122 may transmit the unique URL corresponding to an electronic invoice of a customer to a mobile phone number of the customer via a messaging service.

Database 118 stores electronic invoices or electronic copies of printed invoices of a customer(s). In an implementation, database 118 stores electronic invoices generated by an invoice generation module upon a sale transaction. Database 118 also records a mobile phone number(s) of a customer against his or her electronic invoices. For instance, if there are multiple electronic invoices of a customer (for example, due to multiple sale transactions), all of them are associated with a mobile phone number of the customer. Database 118 may also store a unique Uniform Resource Locator (URL) corresponding to an electronic invoice of a customer.

Mobile phone 120 may be a multimedia phone, a smart phone, a personal digital assistant (PDA), a phablet, a tablet, or a like device with a unique identification number (such as phone number, International Mobile Equipment Identity (IMEI) number, etc.) that could identify the device. Mobile phone 120 is enabled to receive a message using a messaging service. For example, mobile phone 120 may receive Short Messaging Service (SMS) messages, emails, chat messages, and the like. In an implementation, mobile phone 120 could receive a Uniform Resource Locator (URL) in a message such as a SMS message, an email, and a chat message.

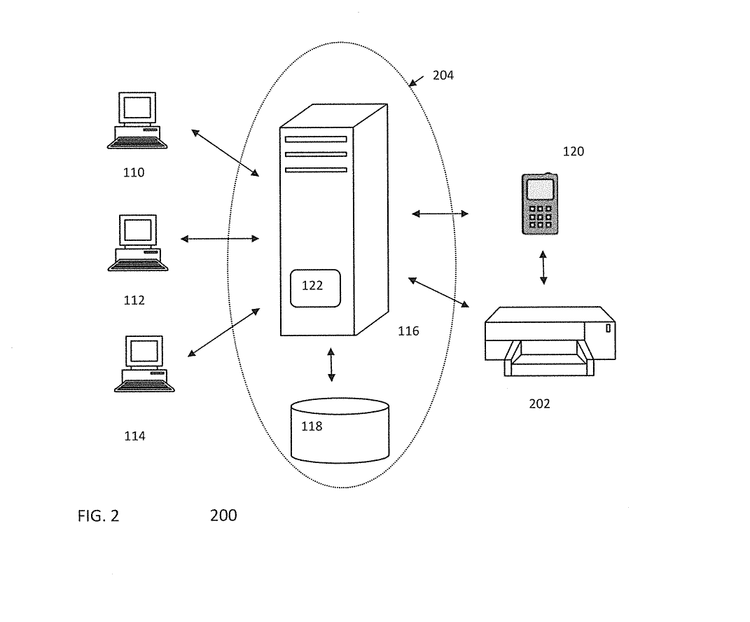

FIG. 2 is a schematic block diagram of an electronic invoice printing system based on electronic invoice management system of FIG. 1, according to an example.

Electronic invoice printing system 200 comprises electronic invoice management system 100 and printer 202. In an implementation, computer server 116 and/or database 118 are hosted in a cloud which may be public or private, or a datacenter server 204. Generally speaking, cloud computing involves delivery of computing as a service rather than a product whereby shared resources (software, storage resources, etc.) are provided to computing devices as a service. The resources are shared over a network, which is typically the internet. In the present context, computer server 116 could be a cloud computing server and database 118 may be a cloud resource.

Printer 202 is a peripheral device which produces a representation of an electronic document on physical media such as paper. Some non-limiting examples of printer 120 may include a dot-matrix printer, an inkjet printer, a laser printer, etc. Printer 120 may include a multifunction printer (MFP), also known as multi-function device (MFD), or all-in-one (AIO) printer. A MFP can print, scan, and copy among their many features. Printer 202 may include a memory, a communication unit for communicating with another computing device such as a mobile device, and a processor for controlling the memory and the communication unit. In an example, printer 202 is a network printer which may be connected to computer server 116 over a Local Area Network (LAN), Wireless Area Network (WAN), or the Internet. In an implementation, a user can print an invoice available in electronic invoice management system 100 through a network printer by downloading a copy of the invoice on his or her mobile phone (from database 118) and transmitting it to the network printer for printing.

In another example, printer 202 is a cloud enabled or cloud ready printer. Cloud enabled printers connect directly to a cloud (for instance, through the Internet) and don't require a computer to setup. They register directly with a cloud service on the Internet and are typically always available. In an implementation, a cloud print platform (“cloud service”) may be present in cloud 204. The cloud print platform could be integrated with electronic invoice management system 100 to enable a user to obtain a print out of his or her electronic invoices (from database 118) using a cloud enabled printer. In an implementation, the cloud print platform assigns a unique email address to a cloud enabled printer.

Assuming that a user has an access to a cloud enabled printer which could be coupled to the cloud print platform, a user can obtain a print of an electronic invoice available in electronic invoice management system 100 by sending an email to the cloud print platform from his mobile phone. In one scenario, the email message could include a unique URL corresponding to an electronic invoice of the user. In this case, the cloud print platform first retrieves the electronic invoice from the electronic invoice management system 100 using the unique URL and then processes it for printing by a cloud enabled printer. In another scenario, if a user downloads a copy of an invoice from electronic invoice management system 100 on his or her mobile device, the downloaded invoice may be sent as an attachment in an email message to the cloud print platform which may then process it for printing by a cloud enabled printer. The cloud enabled printer prints an electronic invoice upon invoice from a cloud print platform.

In another example, printer 202 is an HP ePrint-enabled printer. HP ePrint is a term used by Hewlett-Packard Company to describe a variety of printing technologies developed for mobile computing devices. In an implementation, to print an electronic invoice accessible through electronic invoice management system 100, a user may use a mobile app or a browser on his or her mobile phone to open the unique URL associated with the invoice. The user can then select a print option to send the electronic invoice to an ePrint enabled printer.

In a yet another example, printer 202 is an HP Open Extensibility Platform (HP OXPd) enabled printer. HP Open Extensibility Platform (HP OXPd) is a software development platform by Hewlett-Packard Company and is a standard feature for many printers manufactured by the company. In an implementation, to print an electronic invoice available through electronic invoice management system 100, a user may retrieve a URL (corresponding to an electronic invoice) from a communication message sent by the system 100 on his or her mobile phone. The user can then enter the URL into an OXPd enabled printer using, for instance, a keypad on the printer. The OXPd printer transmits the URL to an OXPd server, which is integrated with electronic invoice management system 100. The OXPd server retrieves a copy of the electronic invoice (corresponding to the URL) from electronic invoice management system 100 and processes it for printing by an OXPd enabled printer. The OXPd enabled printer prints the electronic invoice upon invoice from the OXPd server. In an implementation, a user may be requested to provide authentication details to electronic invoice management system 100 before a request from OXPd server is processed.

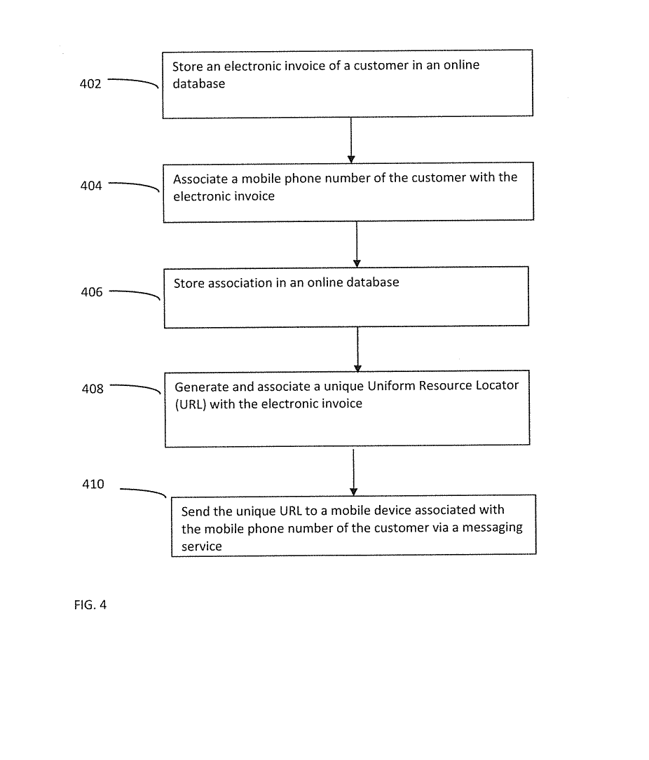

FIG. 4 shows a flow chart of a method of managing electronic invoices, according to an example

At block 402, an electronic invoice of a customer is stored in a database. In an example, an electronic invoice for a product or service purchased by a customer is generated when a sale transaction is carried out. This may occur, for instance, in a retail outlet or during an online purchase. An electronic invoice may be generated by a source system (such as source systems 110, 112 and 114) in particular by an invoice generation module which may be a component of a source system. A source system may capture a plurality of transaction details related to a sale (such as invoice date, product details, price of a product, total invoice amount, customer name, etc.) and generate an electronic invoice for a customer. An electronic invoice thus is a record of a sale transaction. In the present case, an electronic invoice generated by a source system is saved in a database, which may be an online database. In another implementation, an electronic invoice of a customer may be saved in a cloud storage or any other file repository.

At block 404, a mobile phone number of a customer is associated with an electronic invoice of the customer. In other words, a customer's mobile phone number is captured against his or her electronic purchase invoice. This could be done in many ways. To provide an illustration, during a sale transaction in a retail store, a billing assistant may ask for a customer's mobile phone number at the time of billing. The mobile phone number is then fed into an invoice generation module which associates the phone number with the customer's invoice. In another illustration, in case of an online transaction, an e-commerce portal may capture and associate a customer's mobile phone number with his or her electronic invoice or invoice. In an implementation, any future electronic invoices generated for a customer are also associated with his or her mobile phone number.

At block 406, the association between a mobile phone number of a customer and the customer's electronic invoices is stored in a database. In an implementation, an invoice generation module transmits a customer's electronic invoice along with an associated mobile phone number to an electronic invoice management module on a computer server. The electronic invoice management module records the association in a database (for instance database 118).

At block 408, a unique Uniform Resource Locator (URL) is generated and associated with an electronic invoice stored at block 402. In an implementation, an electronic invoice management module generates and associates a unique Uniform Resource Locator (URL) with an electronic invoice of a customer. The unique Uniform Resource Locator (URL) is stored along with the related electronic invoice in a database. The aforesaid URL represents a unique address for the associated electronic invoice in database. In other word, each unique URL is an access to a unique electronic invoice of a customer. In an implementation, stored electronic invoices may be organized, for instance, according to the retailer, product type, date, etc.

At block 410, once a unique Uniform Resource Locator (URL) is generated and associated with an electronic invoice of a customer, the said URL is sent to the mobile phone number of the customer via a messaging service. In other words, the unique URL is transmitted to a mobile device associated with the mobile phone number of a customer. In an implementation, the unique URL is transmitted by an electronic invoice management module via a Short Messaging Service (SMS). In such case, a customer receives a unique URL in a SMS message. In other implementations, the unique URL may be sent using an email program or a chat program. In such events, a customer would receive the URL in an email message and a chat message respectively. In an implementation, a user may indicate his or her preference for a messaging service. For instance, a user may prefer to receive a unique URL by email. A user's preference for a particular messaging service may be captured during a sale transaction.

Once a customer receives a unique URL via a messaging service, for example via a Short Messaging Service (SMS), the customer can access an electronic invoice associated with the URL by selecting the URL on his or her mobile device. A customer may select a URL in many ways, for instance by tapping on the touch screen of the mobile device or through a key press on a key pad of the mobile device. A customer may access all of his electronic invoices stored in a database in like manner. A customer can also download, save and share a copy of an electronic invoice to his or her mobile device.

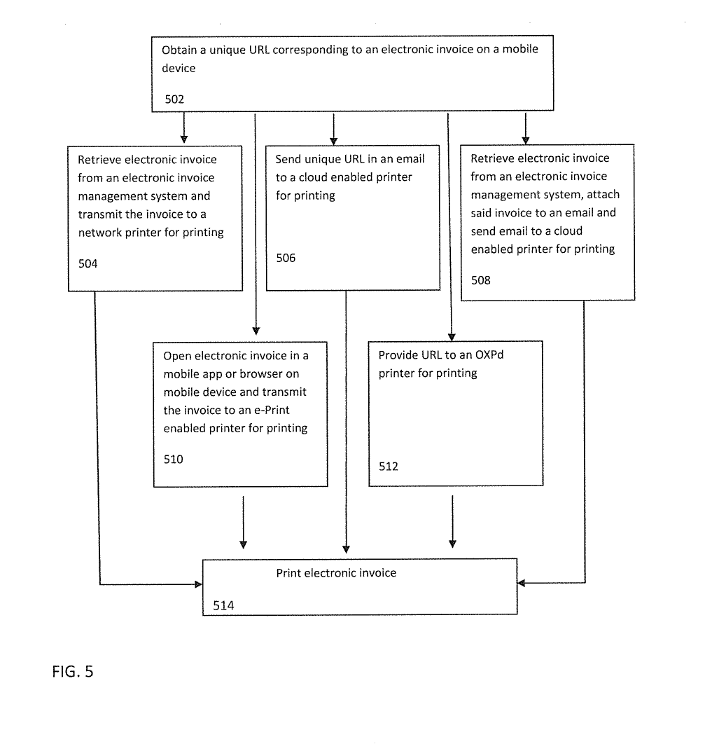

FIG. 5 shows a flow chart of a method of printing electronic invoices, according to an example. At block 502, an electronic invoice management system such as illustrated in FIG. 1 is accessed by a user to view or download an electronic invoice. The electronic invoice management system maintains electronic invoices of a customer in a database. In an implementation, an electronic invoice in the database is accessed by selecting a unique URL corresponding to the electronic invoice on a mobile device. The unique URL may be present in a message (for example, a SMS message) sent from the electronic invoice management system and received by a user on his or her mobile device. The user selects the unique URL to view or retrieve a copy of an electronic invoice from the electronic invoice management system.

Once a user has retrieved an electronic invoice from an electronic invoice management system, the user may print the electronic invoice by transmitting it to a network printer (block 504) through a wireless network (such as Wi-Fi), by sending the unique URL via an email to a cloud enabled printer (block 506), or by sending an email to a cloud enabled printer with the electronic invoice as an attachment (block 508). In an implementation, a user could print an electronic invoice from an electronic invoice management system by opening an associated unique URL in a mobile app or browser on his mobile device and selecting a print option in the app or the browser. The electronic invoice is then sent to an e-Print enabled printer (block 510). In another implementation, an electronic invoice may be printed by providing an associated unique URL to an OXPd printer. The OXPd printer transmits the URL to an OXPD server which retrieves an electronic invoice corresponding to the URL from an electronic invoice management system. The retrieved invoice is sent to the OXPd printer for printing (block 512). In a yet another implementation, a user can forward a SMS message containing a unique URL to a printer which is capable of retrieving and printing content associated with the unique URL. At block 514, an electronic invoice shared with a printer using either of the aforesaid methods is printed.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in the illustrated figures are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. An method of managing electronic invoices, comprising:
storing an electronic invoice of a customer in an online database;
associating a mobile phone number of the customer with the electronic invoice;
storing said association in the online database;
generating and associating a unique Uniform Resource Locator (URL) with the electronic invoice; and
sending the unique URL to a mobile device associated with the mobile phone number of the customer via a messaging service.

2. The method of claim 1, further comprising enabling access to the electronic invoice in the online database from the mobile device upon selection of is the unique URL.

3. The method of claim 1, further comprising enabling retrieval of the electronic invoice from the online database to the mobile device using the unique URL.

4. The method of claim 1, further comprising enabling printing of the electronic invoice in the online database by sending the unique URL via an email message to a cloud enabled printer.

5. The method of claim 1, further comprising enabling printing of the electronic invoice in the online database by providing the unique URL to an Open Extensibility Platform (OXPd) enabled printer, wherein the OXPd enabled printer retrieves the electronic invoice from the online database prior to the printing.

6. The method of claim 1, wherein the messaging service is one of a Short Message Service (SMS), an electronic mail (email) and a chat message service.

7. The method of claim 1, wherein the mobile device receives the unique URL via one of a Short Message Service (SMS) message, an email message and a chat message.

8. The method of claim 1, wherein the messaging service is selected by the customer.

9. The method of claim 1, wherein the online database is present in a cloud.

10. A method of printing an electronic invoice, comprising:
receiving, via a messaging service, a unique Uniform Resource Locator (URL) on a mobile device, wherein the unique URL is associated with an electronic invoice stored in an online database;
retrieving the electronic invoice from the online database to the mobile device using the unique URL;
sending the electronic invoice from the mobile device to a cloud-enabled printer; and
printing the electronic invoice using the cloud-enabled printer.

11. The method of claim 10, wherein the electronic invoice is sent as an email attachment to the cloud-enabled printer.

12. A method of printing an electronic invoice, comprising:
receiving, via a messaging service, a unique Uniform Resource Locator (URL) on a mobile device, wherein the unique URL is associated with an electronic invoice stored in an online database;
sending the unique URL via an email from the mobile device to a cloud-enabled printer;
retrieving the electronic invoice from the online database using the unique URL;
and
printing the electronic invoice using the cloud-enabled printer.

13. A printer, comprising:
a memory;
a communication unit for communicating with a mobile device; and
a processor for controlling the memory and the communication interface, wherein
the processor, upon invoice of a unique Uniform Resource Locator (URL) from the mobile device, retrieves an electronic invoice associated with the unique URL from an online database and prints the electronic invoice.

14. The printer of claim 13, wherein the unique URL is received from the mobile device via an email message.

15. The printer of claim 13, wherein the unique URL is received from the mobile device wirelessly.
